(19) United States
(12) Patent Application Publication
(10) Pub. No.: US 2024/0007043 A1
(43) Pub. Date: Jan. 4, 2024

(54) ADJUSTABLE PHOTOVOLTAIC UNIT

(71) Applicant: Generators Australia Pty Ltd, Canning Vale (AU)

(72) Inventor: Ciaran Maughan, Canning Vale (AU)

(21) Appl. No.: 18/369,063

(22) Filed: Sep. 15, 2023

Related U.S. Application Data
(63) Continuation of application No. PCT/AU2022/050513, filed on May 26, 2022.

(30) Foreign Application Priority Data
May 28, 2021 (AU) 2021901606

(51) Int. Cl. H02S 20/30; H02S 10/40; H02S 40/34

(52) U.S. Cl. CPC H02S 20/30; H02S 10/40; H02S 40/34

(57) ABSTRACT

An adjustable photovoltaic unit for providing electricity. The unit comprising: a base; one or more electrically connected photovoltaic panels pivotally mounted at an in-use lower region thereof with respect to the base; at least one length adjustable brace. One end of the brace being pivotally mounted with respect to the base. An opposing end of the brace being pivotally connected with respect to the one or more panels at a location remote from where the one or more panels are mounted at the lower region. The angle of inclination of the one or more panels with respect to the base is able to be varied by adjusting the length of the at least one brace.

### CROSS-REFERENCE TO RELATED APPLICATIONS

This patent application claims the benefit of PCT application No. PCT/AU2022/050513, filed May 26, 2022, and Australian patent application No. AU2021901606, filed May 28, 2021, the disclosures of which are incorporated by reference herein in their entireties.

### TECHNICAL FIELD

Disclosed herein is an adjustable photovoltaic unit for providing electricity. The unit can be portable such that it can be transported to and used remotely.

### BACKGROUND

Photovoltaic arrays for providing electricity are known. For example, WO2016/049710 discloses a portable solar photovoltaic array whereby the solar panel array modules are connected together so as to form a concertinaed complete portable solar array which expands out on deployment into an inter-connected array, or folds into a smaller area for transportation.

Whilst systems such as these are suitable for very large projects requiring a large amount of electricity to be generated by the solar array, there is a need for a more portable and readily adjustable in the field solar panel system which is also able to be expanded into larger arrays if required. However, if a portable (e.g. more lightweight) system were to be provided, it would need to account for e.g. weather conditions (e.g. extreme weather in remote locations).

Large scale in-field solar panel systems such as WO2016/049710 also have the disadvantage that they are extremely heavy and typically require more than one person to adjust the system. A portable solar array that is adjustable in the field, such as by a single person, could provide an advantage to the known prior art.

A reference herein to the prior art does not constitute an admission that such prior art forms a part of the common general knowledge in the art, in Australia or any other country.

### SUMMARY OF THE DISCLOSURE

Disclosed herein in a first aspect is an adjustable photovoltaic unit for providing electricity. The unit can be fabricated to be portable such that it can be transported to and used in remote locations (e.g. to provide ‘off the grid’ power).

The unit can comprise a base. One or more electrically connected photovoltaic panels can be pivotally mounted at an in-use lower region thereof with respect to the base. The unit can also comprise at least one length adjustable brace. One end of the brace can be pivotally mounted with respect to the base. An opposing end of the brace can be pivotally connected with respect to the one or more panels at a location remote from where the panel(s) are mounted at the lower region. The angle of inclination of the one or more panels with respect to the base can be varied by adjusting the length of the at least one brace. For example, the panel(s) can be arranged to pivot between a collapsed (e.g. transport) configuration and one or more erected (e.g. in-use) configurations. The length-adjustable brace can support the panel(s) at the or each of the one or more erected configurations. The length-adjustable brace may also maintain the panel(s) at the or each of the one or more erected configurations.

The unit as disclosed herein can provide a simple and yet robust way of generating electricity at remote locations (e.g. to provide ‘off the grid’ power to an isolated community, industrial operation, etc.). The unit as disclosed herein can provide a simple way of adjusting the panels to accommodate different angles of incidence of solar radiation (e.g. for different times of the day, different seasons, different latitudinal locations, etc.). For example, the unit may be adjustable by a single user.

The unit can comprise a base and one or more electrically connected photovoltaic panels. The unit can also comprise a frame that is pivotably mounted to the base at an in-use lower region thereof. The one or more electrically connected photovoltaic panels can be mounted to the frame. The unit can also comprise at least one length adjustable brace, one end of the brace being pivotally mounted with respect to the base, an opposing end of the brace being pivotally connected with respect to the frame at a location remote from where the frame is mounted to the base. The unit can also comprise a strut configured to apply a lifting force to the frame with respect to the base. An angle of inclination of the one or more panels with respect to the base is able to be varied by adjusting the length of the at least one brace.

In some embodiments, the unit may comprise at least two length adjustable braces. The length adjustable braces can be spaced apart with respect to the base. One of the braces may be mounted adjacent to one end of the base to extend up in use to connect adjacent to one end of the panel(s). Another of the braces may be located adjacent to an opposite end of the base to extend up in use to connect adjacent to an opposite end of the panel(s). Providing at least two length adjustable braces can result in a more stable unit, in that the photovoltaic panel(s) can be supported at two or more points at the various angles of inclination.

In some embodiments, the unit may comprise one or more gas struts (e.g. in addition to the at least one brace). The gas struts can be configured to assist in the pivotal movement of the panel(s) with respect to the base. For example, the gas strut(s) may assist a user with the lifting and pivoting of the panel(s)—e.g. from a collapsed to one or more erected configurations. The gas strut(s) may help the user hold the erected panels at a given erected position until a length of brace is selected. One end of each gas strut may be pivotally mounted with respect to the base. An opposing end of each gas strut may be pivotally connected with respect to the panel(s) at a location remote from where the panel(s) are mounted at the lower region. In some embodiments, the unit may comprise at least two gas struts. One of the gas struts may be located adjacent to one of the braces. Another of the gas struts may be located adjacent to the other brace. Using two or more gas struts can provide greater leverage and mechanical advantage.

In some embodiments, the adjustable photovoltaic unit may comprise an intermediate gas strut assembly positioned between two of the at least two gas struts. The intermediate gas strut assembly may be configured to assist in the pivotal movement of the panel(s) with respect to the base. One end of the intermediate gas strut assembly may be pivotally mounted with respect to the base. An opposing end of the intermediate gas strut assembly may be pivotally connected with respect to the panel(s) at a location remote from where the panel(s) are mounted at the lower region.

In some embodiments, the adjustable photovoltaic unit may be configured such that the intermediate gas strut assembly comprises a third gas strut at an end of the intermediate gas strut assembly closest to the base, and at least two tubular portions in a telescopic configuration that comprises an outer tubular portion and an inner tubular portion configured to slide into and out of the outer tubular portion. A length of the intermediate gas strut assembly may be adjustable. An upper end of the outer tubular portion may be pivotably connected with respect to the panel(s) at the location remote from where the panel(s) are mounted at the lower region. An in-use lower end of the inner telescoping tubular portion may be mounted to the third gas strut. The third gas strut may be configured to provide initial lift to the panel.

In some embodiments, the one or more panels may be mounted on a sub-frame. The sub-frame can provide rigidity and support to the panel(s) in use. The sub-frame may be pivotally mounted to the base at an in-use lower side of the sub-frame. The opposing end of each brace may be pivotally connected to the sub-frame at a location remote from the lower side of the sub-frame. Thus, in use, each brace holds the sub-frame at one or more erected configurations, thereby maintaining the panel(s) at one or more erected positions.

In some embodiments, the unit may comprise one or more handles attached with respect to the panel(s). For example, each handle may be attached to the sub-frame. The handle(s) enable the panel(s) to be pivoted up or down (i.e. by a user) with respect to the base around the pivotal mounting at the lower region thereof.

In some embodiments, each of the braces may have a telescopic configuration (i.e. for its length adjustment). Such configurations are robust and reliable over time. For example, each brace may comprise an outer base arm and an inner telescoping arm. The inner telescoping arm may slide into and out of the base arm. The length of the brace may be adjusted by such sliding. In some embodiments, an in-use lower end of the base arm may be pivotally mounted with respect to the base. An in-use upper end of the inner arm may be pivotally connected with respect to the panel(s)—e.g. to the sub-frame.

In other embodiments, each of the braces may have a more complex configuration (e.g. each brace may take the form of a length adjustable—e.g. hydraulic or pneumatic—arm or ram). However, for remote and isolated applications of the unit, a more simple and reliable mechanical (e.g. telescopic) brace can be favoured.

In some embodiments, each of the braces may comprise a locking pin. The locking pin may be configured to selectively lock the sliding of the inner arm with respect to the base arm (e.g. through appropriately aligned holes in each of the arms). Each brace may be adjustable to a number of different lengths. Each brace may be locked (i.e. by the locking pin) in that number of different lengths. The locking pin may comprise a separate but tethered pin, a captive (e.g. spring-loaded) pin, a detent-type catch, etc.

In some embodiments, the panel(s) may be configured to pivot with respect to the base between a collapsed configuration and at least one erected configuration. In the collapsed configuration, an underside of the panel(s) may overlie the base. In the at least one erected configuration, the panel(s) can extend up and away from the base at a given angle of inclination.

In some embodiments, the base of the unit may comprise at least one stop. For example, the base may comprise two spaced-apart stops. When the panel(s) are in the collapsed configuration, an underside of the panel(s) (e.g. the sub-frame) can rest with respect to (e.g. on top of) the at least one stop. The stop(s) may be provided with a deflection or spring-like characteristic should, for example, the panel(s) (e.g. sub-frame) be dropped or firmly pushed onto the stops (i.e. to protect the panel(s) and the base of the unit).

In some embodiments, the base of the unit may comprise a frame. Use of framework can lighten the base without compromising its strength. The frame may comprise a perimeter framework. The frame may also comprise an internal framework. The internal framework may extend within and may be connected to the perimeter framework. The internal framework may be configured to receive thereon the panel(s) (e.g. to receive thereon the sub-frame).

In some embodiments, one (i.e. in-use lower) end of each brace may be pivotally mounted to the internal framework of the base. Further, the internal framework may be recessed within the perimeter framework. When in the collapsed configuration, the panel(s) (e.g. including the sub-frame) may overlie the internal framework and can be located within (e.g. to be surrounded and protected by) the perimeter framework.

In some embodiments, the internal framework may further comprise spaced-apart hollow sections. The hollow sections may extend transversely between opposite respective openings defined in opposing sides of the perimeter framework (e.g. when the base is rectangular, the hollow sections may extend between opposing long sides of the perimeter framework). Each hollow section may be configured so as to slidingly receive therein a respective tine of a vehicle such as a forklift. This can allow for ready movement, placement and transport of the unit. Transversely extending hollow sections can also provide strength and rigidity to the base.

In some embodiments, the perimeter framework of the unit may comprise a plurality of spaced apertures through sidewalls and/or end walls thereof. The apertures can enable air (e.g. wind) to flow through the base. In this regard, air may flow from one side/end of the perimeter framework to the other. Such air flow can assist in wind load reduction on the unit when located ‘out in the field’.

In some embodiments, the base of the unit may comprise a number of alignment members. The alignment members can enable modules (e.g. like modules) to be stacked (i.e. one above the other). For example, each alignment member can be located at a respective corner of the base. Each alignment member can be configured to receive and locate an underside corner of a respective overlying like base of an overlying like module. For example, an alignment member may be provided at each corner of the base. Each alignment member may comprise two flared flanges. The flanges may each extend along and project up and out from a respective side/end of the base at the respective corner. The flanges can act as both guide and retention surfaces (i.e. to guide and then locate/retain the underside corner of an overlying unit).

In some embodiments, each of opposing end walls of the base may comprise spaced-apart pin-receiving brackets. The pin-receiving brackets may be located externally thereat. In use, when the units are stacked, each bracket may be aligned with a corresponding bracket of an overlying unit. Then, a respective locator pin can be extended through the aligned brackets to thereby secure the units against lateral movement when stacked. For example, the locator pin may be configured to wedge into the aligned brackets.

In some embodiments, each of opposing end walls and/or side walls of the base can comprise one or more ground-securing formations. Each ground-securing formation may comprise a tube. The tube may be fastened (e.g. welded) to a respective wall of the base. Each ground-securing formation may be located externally on a respective base wall. Each ground-securing formation may be arranged and configured to receive a ground-engaging peg therethrough. In use, when the base is located on the ground, a ground-engaging peg may be driven into the ground, the peg extending through and being retained at a respective ground-securing formation to thereby secure the base at the ground. Each ground-securing formation may be arranged on its respective base wall such that, in use, the peg can be driven into the ground in a skewed-to-vertical orientation.

In some embodiments of the adjustable photovoltaic unit, the one or more end wall and/or side wall of the base may comprise one or more foundation-securing formations. Each foundation-securing formation may be located externally on the respective end wall or side wall and arranged to receive a foundation-engaging peg. The arrangement may be such that when the base is located on a foundation, the foundation-engaging peg can be inserted into the foundation to secure the base to the foundation.

In some embodiments, the one or more side wall and/or end wall of the base of the adjustable photovoltaic unit, may comprise one or more lifting formations. Each lifting formation may be located externally on the respective side wall or end wall. Each lifting formation maybe arranged and configured to receive a hook through a hole of the respective lifting formation.

In some embodiments, the unit may comprise two or more electrically connected photovoltaic panels. Each of the panels may be of the same dimension. The two or more panels may be arranged in the unit to be adjacent to each other in a row. The row may extend between opposing ends of the base. Alternatively, or additionally, the two or more panels may be arranged in the unit to be adjacent to each other in a column. The column may extend between opposing sides (e.g. long sides) of the base. For example, a specific embodiment of the unit may comprise two rows of panels and up to four columns of panels—two panels in each column (i.e. eight panels in total). Each panel may have multiple banks of solar cells arrayed therein.

The two or more panels may be surrounded by and contained within an external panel perimeter frame. The panel perimeter frame may be connected to the sub-frame. The panel perimeter frame (and sub-frame) may enable the two or more panels to pivot as a unit about the lower region and with respect to the base.

In some embodiments, the unit may further comprise a DC isolator component located within the base. The DC isolator component may be configured to enable the offtake of electricity generated by the panel(s). At least one (electrical) cable may extend from the panel(s) to the DC isolator component. The DC isolator component may be located at a rear side of the base, opposite a front side at which the panel(s) pivot (i.e. so as to be isolated from the panel(s)).

In some embodiments, the unit may be further configured such that, in use, an electrical connection may be established between adjacent units. The units may be interconnected via a respective cable extending between adjacent units. The DC isolator component may be connected via a further cable from the DC isolator of a first unit, along cable trays which may be placed along the side of the base adjacent the DC isolator and along the front side of the base (at which the panel(s) pivot), through an opening in the opposite side of the base into an opening in the base of an adjacent unit. The further cable may feed from a DC isolator component of one unit to a DC isolator component of an adjacent unit and so on. The units may be electrically connected in series or in parallel. The final unit in the series or parallel configuration may be connected to a power storage device and/or conversion device for either storing and/or converting the electricity generated to a useable parameter for subsequent use.

In some embodiments, each opening within an end wall of the base may be covered by a grommet such as of rubber (e.g. to provide electrical insulation). The further cable may extend through the grommet.

Also disclosed herein in a second aspect is an adjustable photovoltaic unit for providing electricity. The unit can be as set forth above for the first aspect. In this regard, the panel(s) can be pivotally mounted with respect to the base for movement between a collapsed configuration and one or more erected configurations.

In the second aspect, the base of the unit can comprise at least two alignment members. Each alignment member can be as set forth above for the first aspect. Each alignment member can be located at a respective corner of the base. For example, the at least two alignment members may be located at respective, diagonally-opposing corners of the base. When the panel(s) are in the collapsed configuration, each alignment member can be configured to receive and locate an underside corner of a respective overlying like base of an overlying like unit (e.g. to guide, locate and retain the corner thereat). The alignment members can enable a plurality of units to be stacked. This can facilitate each of storage and transportation of the units.

Also disclosed herein in a third aspect is an adjustable photovoltaic unit for providing electricity. The unit can be as set forth above for each of the first and second aspects. In this regard, the panel(s) can be pivotally mounted with respect to the base for movement between a collapsed configuration and one or more erected configurations.

In the third aspect, an external wall (e.g. one or both end walls) of the base can comprise at least one ground-securing formation. Each ground-securing formation can be arranged and configured to receive a ground-engaging peg therethrough. Thus, when the base is located on the ground in use, a ground-engaging peg can be driven into the ground to secure the base at the ground. This can facilitate usage of the units at remote locations (e.g. which may be subject to extreme or variable weather conditions, such as high wind loadings and/or flooding).

As set forth above for the first aspect, each ground-securing formation may take the form of a tube. When the tube is configured in a skewed-to-vertical orientation, the peg extending through can be skew-driven into the ground. This can help to secure the unit against such wind-loading, flooding, etc.

Also disclosed herein in a fourth aspect is an adjustable photovoltaic unit for providing electricity. The unit can be as set forth above for each of the first to third aspects. In this regard, the panel(s) can be pivotally mounted with respect to the base for movement between a collapsed configuration and one or more erected configurations.

In the fourth aspect, an external wall of the base may comprise at least one pin-receiving bracket. In use, when the units are stacked, a given bracket may be aligned with a corresponding bracket of an overlying unit. Then, a respective locator pin can be extended through the aligned brackets to thereby secure the units against lateral movement when stacked. For example, the locator pin may be configured to wedge into the aligned brackets.

### BRIEF DESCRIPTION OF THE DRAWINGS

One or more embodiments of the adjustable photovoltaic unit will now be described, by way of example only, with reference to the accompanying Figures, in which:

FIG. 1 shows a perspective view of a framework skeleton for an embodiment of the adjustable photovoltaic unit, the framework shown in one of a number of possible erected positions.

FIG. 2 shows a similar perspective view to FIG. 1, but with solar panels mounted to the framework to form the unit.

FIG. 3 shows a right-side end view of the photovoltaic unit of FIG. 2.

FIG. 4 shows a rear view of the photovoltaic unit of FIG. 2.

FIG. 5 shows a perspective front end view of a specific embodiment of the adjustable photovoltaic unit when in another of the erected positions.

FIG. 6 shows another perspective rear end view of the unit of FIG. 5.

FIG. 7 shows a perspective rear view detail of the unit of FIG. 5, with FIG. 7A being a detail of the panel hinge region of FIG. 7.

FIG. 8 shows a perspective front view of the collapsed photovoltaic unit of FIG. 2.

FIGS. 8A, 8B and 9 show various interior detail views of the unit of FIG. 5.

FIGS. 10 and 11 show various exterior detail views of the unit of FIG. 5.

FIG. 12 shows a schematic of a network of interconnected adjustable photovoltaic units, each in an erected position, each connected in series and providing power to a power storage and/or conversion facility.

FIG. 13 shows a perspective view of several photovoltaic units, each in the collapsed configuration of FIG. 8, the units stacked in two separate but adjacent stacks on a trailer ready for transportation.

FIG. 14 shows a detail view of the stacked collapsed photovoltaic units of FIG. 13.

FIGS. 15 and 16 are schematic diagrams that illustrate a number of units that are electrically connected in series (FIG. 15) and parallel (FIG. 16).

FIG. 17 shows a perspective view of a framework skeleton for another embodiment of the adjustable photovoltaic unit, the framework shown in one of a number of possible erected positions.

### DETAILED DESCRIPTION

It is to be appreciated that, whilst each of the embodiments is specifically described in detail, the disclosure is not to be construed as being limited to any specific feature or element of any one of the embodiments. Neither is the disclosure to be construed as being limited to any feature of a number of the embodiments or variations described in relation to the embodiments.

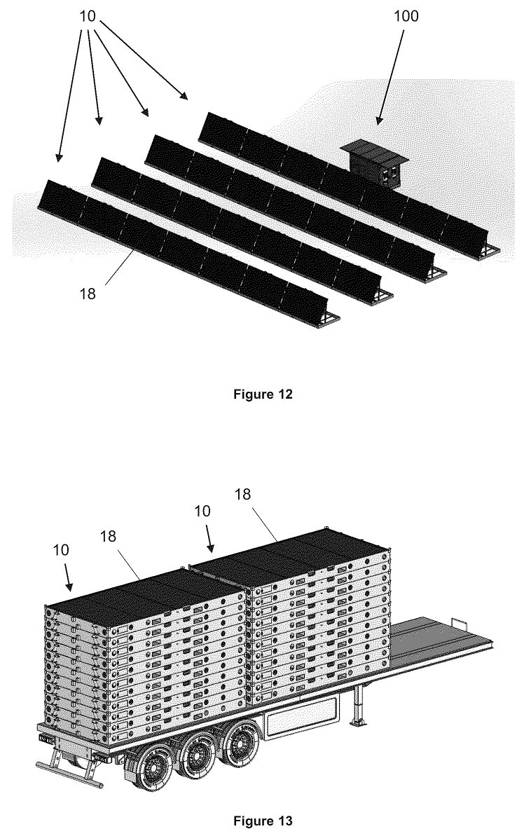

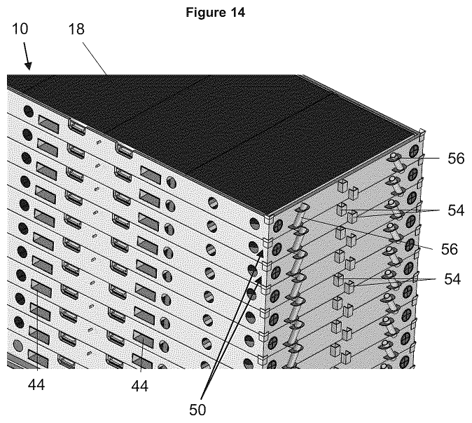

Referring to the Figures, there is shown an adjustable photovoltaic unit in the form of a photovoltaic (solar) skid 10. The solar skid 10 is fabricated to be portable so that it can be transported to and used in remote locations (e.g. to provide ‘off the grid’ power in such locations). The power generated by the solar skid 10 can also be stored at the remote location in batteries (i.e. to provide overnight power) such as in the facility 100 shown in FIG. 12. As explained in further detail hereafter, the solar skid 10 is also suitably fabricated for such remote locations (i.e. for both transportation to the location, in stacks of the solar skids as shown in FIGS. 13 and 14, as well as for secure use in more extreme weather conditions (e.g. high wind and rainfall) that can occur in such remote locations).

The solar skid 10 comprises a base in the form of a base frame 12. The base frame 12 comprises internal framework 14 and external (perimeter) framework 16, as will be explained in greater detail below. The framework is fabricated to be strong and robust and yet also lightens the overall structure and weight of the base frame 12. For example, the framework can be fabricated from aluminium or a lightweight steel alloy, etc.

Whilst just a single photovoltaic (i.e. a single solar) panel can be pivotally mounted to base frame 12, in practice a number of (e.g. four double) electrically connected photovoltaic (solar) panels 18 are pivotally mounted to base frame 12 as shown. This effectively defines one row and four columns of solar panels, as shown. However, other numbers of rows and columns of panels can be employed as required.

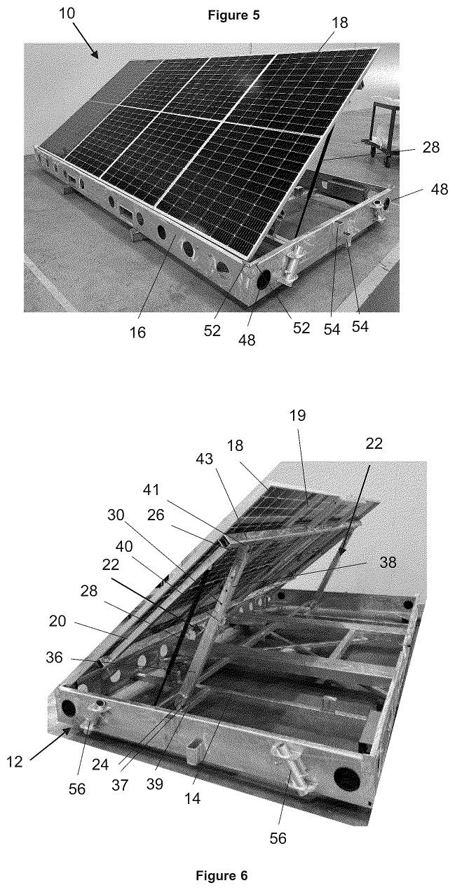

In the embodiments depicted (see e.g. FIG. 5), the four double panels 18 of the solar skid 10 are electrically connected, are of the same dimension and are arranged in the solar skid 10 to be adjacent to each other in a row extending from one end of the solar skid 10 to the other end. It will also be seen that each double panel effectively defines a column of two individual panels that extends between opposing sides (e.g. long sides) of the skid. Each solar panel has multiple banks of solar cells arrayed therein.

Each double panel 18 is surrounded by and contained within an external panel perimeter frame 19 (i.e. four such frames are arranged in the solar skid 10). The panel perimeter frame 19 is in turn connected (e.g. spot-welded) to a sub-frame in the form of a tilt frame 20. The panel perimeter frame 19 and tilt frame 20 thereby pivot as one at an in-use lower region thereof about the base frame 12.

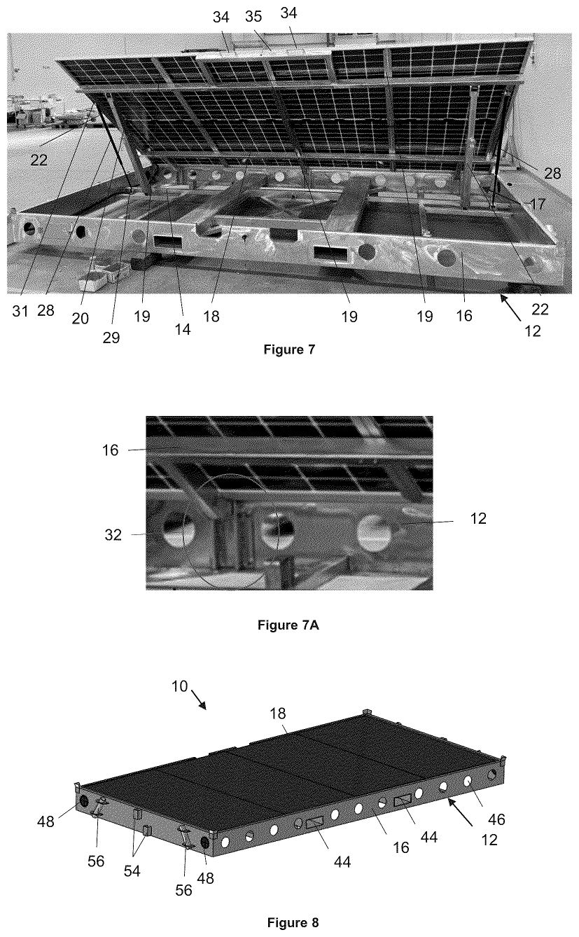

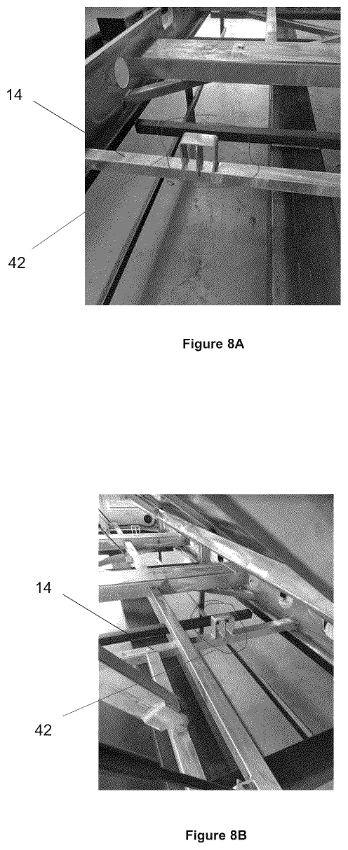

In this regard, the solar panels 18 (including the panel perimeter frame 19 and tilt frame 20) pivot with respect to the base frame 12 between a collapsed configuration (i.e. in which the solar panels 18 overlie the base frame 12 as shown in FIG. 8) and one or more erected configurations (i.e. in which the solar panels 18 extend up and away from the base frame 12, as shown). As will be explained in greater detail below, the solar panels 18 are indirectly pivotally mounted to the base frame 12 via the tilt frame 20. In the embodiments depicted, it is the tilt frame 20 that is pivotally mounted at its in-use lower region to the base frame 12. This mounting of the tilt frame is shown and described in more detail below with reference to FIGS. 6 and 7.

The solar skid 10 also comprises at least one length adjustable brace in the form of a length adjustable arm 22. The (or each) arm 22 is pivotally mounted at an in-use arm lower end 24 to the internal framework 14 of base frame 12. The (or each) arm 22 is also pivotally mounted at an in-use arm upper end 26 to the tilt frame 20 (i.e. at a location that is remote from where the tilt frame 20 pivotally mounts at its lower region to the base frame 12). Whilst the solar skid 10 could be used with a single arm 22, in practice, for both stability and robustness, the solar skid 10 typically comprises at least two, spaced length adjustable arms 22 (e.g. located adjacent to opposite ends of the solar skid 10, as explained in greater detail hereafter). When their lengths are set (e.g. locked), the length-adjustable arms 22 can also maintain the solar panels 18 at a given erected orientation.

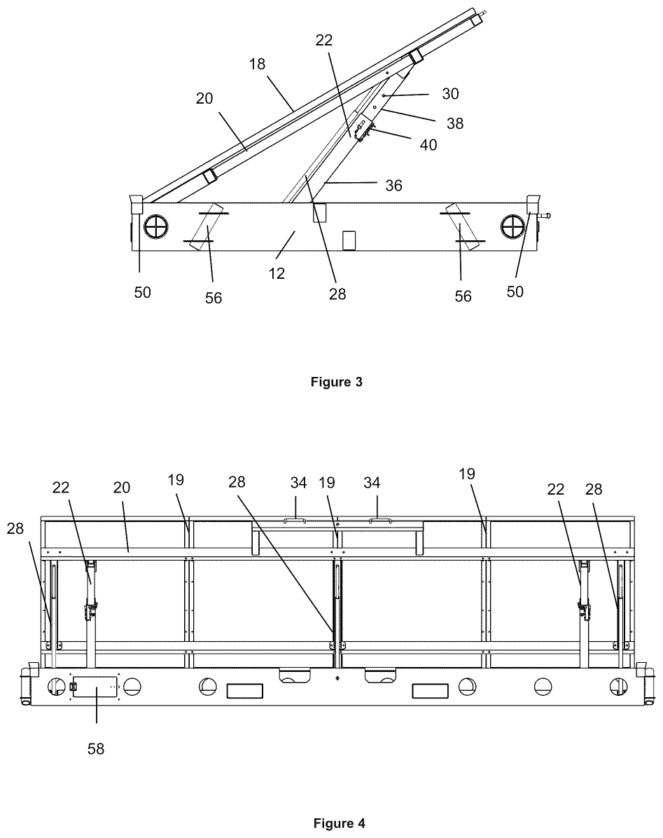

The arm(s) 22 enable the angle of inclination of the solar panels 18 to be varied (i.e. to be adjusted to optimally face incident solar radiation) with respect to the base frame 12. This can be achieved by adjusting and then fixing the length of the arms 22. For example, when the solar panels 18 are in their collapsed (e.g. transport) configuration as shown in FIGS. 8, 13 & 14, the arm(s) 22 assume their shortest length. As the solar panels 18 are pivoted away from the base frame 12 to one or more of their erected (in-use) configurations, the length of each arm 22 is increasingly adjusted and, once at a desired inclination, the arm length is fixed to support the panels 18 at a given one of the erected configurations. The configuration of the arms 22 is described in greater detail below (and with reference to FIGS. 3 and 6).

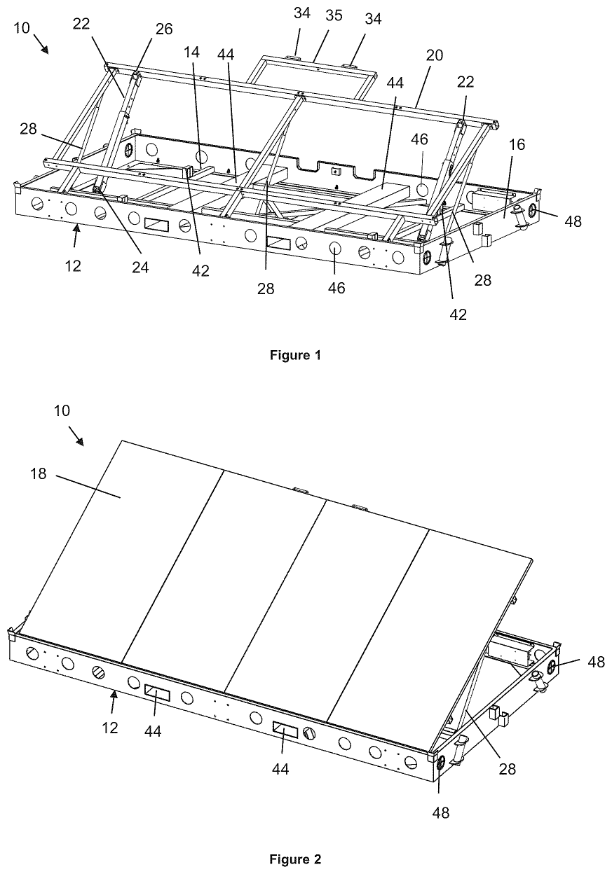

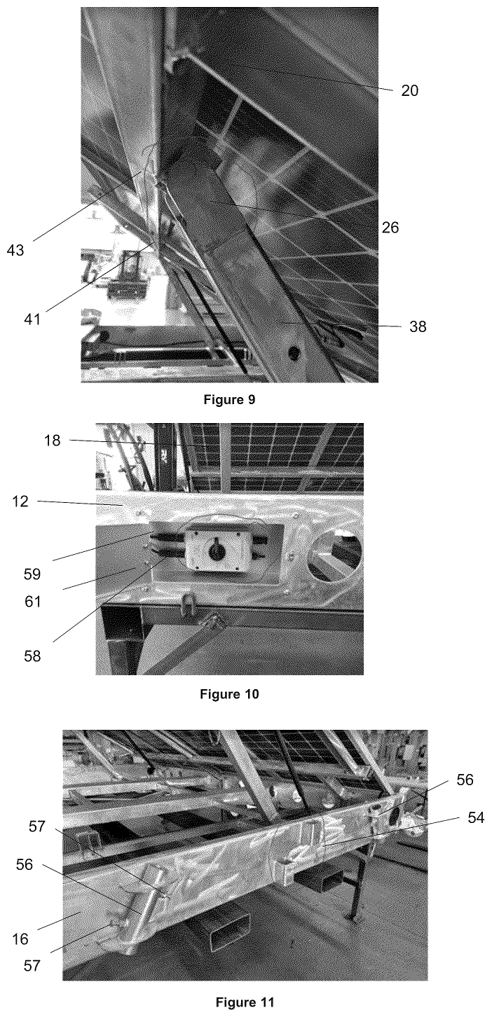

The solar skid 10 further comprises one or more gas struts 28 which are employed to assist with pivoting (i.e. lifting) of the solar panels 18 from their collapsed configuration to the one or more of their erected configurations. Again, whilst the solar skid 10 could be used with a single gas strut, in practice, for increased lift and support, the solar skid 10 typically comprises at least two, and optionally three spaced gas struts 28 (e.g. if two, these struts can be located adjacent to the arms 22 at opposite ends of the solar skid 10, and if three, a third strut can be located between the two opposite end struts 28, as explained in greater detail hereafter). The embodiment of FIGS. 1 to 4 illustrates a solar skid with three gas struts 28, whereas the embodiment of FIGS. 5 to 11 illustrates a solar skid with two gas struts 28.

Whilst the gas struts 28 assist with lifting, they additionally assist a user in holding the solar panels 18 at a given position above the collapsed position, until one of the multiple possible positions (lengths) of the length adjustable arm 22 is selected. As shown in the Figures, the length adjustable arm 22, can be locked at various positions, by utilising a pin 40 through the holes 30 in the length adjustable arm 22. The pin serves to lock the length adjustable arm 22 into position. It should also be understood that if ‘length-lockable’ gas struts were employed, these could take the place of the length adjustable arms 22.

The gas struts 28 are pivotally mounted so that one end 29 is pivotally mounted to the internal framework 14 with respect to the base frame 12, and the other end 31 is pivotally mounted to the tilt frame 20 with respect to the solar panels 18. One of the two or more gas struts 28 may be located adjacent to one of the length adjustable arms 22. Another of the gas struts 28 may be located adjacent to the other length adjustable arm 22. A third gas strut 28 (FIGS. 1 to 4) can be located midway between the other gas struts. Using two or more gas struts 28 can provide greater leverage and mechanical advantage.

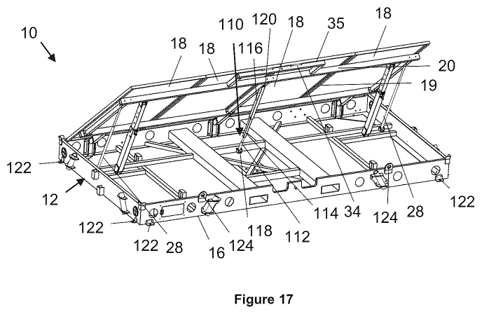

As shown in FIG. 17, in some embodiments, the solar skid 10 comprises an intermediate gas strut assembly 110. The intermediate gas strut assembly 110 comprises a gas strut 112. The gas strut 112 may be referred to as a third gas strut. The intermediate gas strut assembly 110 comprises a first tubular portion 114. The first tubular portion 114 may be referred to as an inner tubular portion. The first tubular portion 114 may be referred to as an inner telescoping tubular portion. The first tubular portion 114 may be hollow. That is, the first tubular portion 114 may define a hollow internal volume. The intermediate gas strut assembly 110 comprises a second tubular portion 116. That is, the intermediate gas strut assembly 110 comprises two tubular portions 114, 116. The second tubular portion 116 may be referred to as an outer tubular portion. The second tubular portion 116 may be referred to as an outer telescoping tubular portion. The second tubular portion 116 may be hollow. That is, the second tubular portion 116 may define a hollow internal volume. It will be appreciated that in some embodiments, the intermediate gas strut assembly 110 may comprise no tubular portions, only one tubular portion or more than two tubular portions. In some embodiments, the intermediate gas strut assembly 110 comprises two or more tubular portions.

The intermediate gas strut assembly 110 is positioned between the other gas struts 28, 28. The positioning of the intermediate gas strut assembly 110 is preferably central between the other gas struts 28, 28. The intermediate gas strut assembly 110 is configured to assist in pivotal movement of the solar panels 18 with respect to the base frame 12. The intermediate gas strut assembly 110 is positioned such that one end 118 of the intermediate gas strut assembly 110 is pivotally mounted with respect to the base frame 12. In particular, the gas strut 112 is pivotally mounted to the base frame 12. An opposing end of the gas strut 112 is connected to the inner tubular portion 114.

The inner tubular portion 114 is in turn connected to the outer tubular portion 116. The outer tubular portion 116 is configured to receive at least part of the inner tubular portion 114 within the interior volume of the outer tubular portion 116 so that the connection between the inner tubular portion 114 and the outer tubular portion 116 is telescopic. In other words, the outer tubular portion 116 is configured to telescopically receive the inner tubular portion 114. The telescoping shortens or lengthens the total length of the intermediate gas strut assembly 110. An upper end 120 of the outer tubular portion 116 is pivotably connected with respect to the solar panels 18. That is, the upper end 120 is pivotably connected to the panel perimeter frame 19 and tilt frame 20. The location of the upper end 120 is preferably remote or distanced from where the solar panels 18 are mounted at the lower region, being near the lifting handles 34, and their extension 35 as shown in FIG. 17, whilst the lower region is the region where the base frame 12 connects to the solar panels 18.

The inclusion of an intermediate gas strut assembly 110 facilitates greater initial lifting of the solar panels 18 by a single person. The intermediate gas strut assembly 110 can take a majority of the load and assist in initial lifting of the solar panels 18 from a flat stowed position. In other words, the intermediate gas strut assembly 110 is configured to provide initial lift to the solar panels 18.

As set forth above, the solar panels 18 are mounted on the tilt frame 20. The tilt frame 20 assists in providing rigidity and support to the solar panels 18 when in use. As best shown in FIG. 7A, the tilt frame 20 is pivotally mounted via a bracket and hinge arrangement 32 to the perimeter framework 16 of base frame 12 (i.e. at three discrete and spaced locations along a front side 17 of the perimeter framework 16). The mounting is such that the tilt frame 20 sits recessed below a flush location of the top of the perimeter framework 16 when the tilt frame is in its collapsed position as shown in FIG. 8. Thus, the solar panels 18 are surrounded and protected by the perimeter framework 16 when in the collapsed (i.e. transport and stacking) configuration as shown in FIGS. 13 and 14. As set forth above, when the tilt frame 20 is raised or erected in use, each length adjustable arm 22 and gas strut 28 holds the tilt frame 20 at a desired erected position.

The solar skid 10 also has one or more handles 34, in the embodiments depicted there are two spaced handles 34 that are attached to an extension part 35 of the tilt frame 20 (see FIGS. 4 and 7). The handles 34 assist a user in erecting or collapsing of the solar panels 18 on tilt frame 20. In this regard, the handles 34 enable a user to lift and pivot the solar panels 18 up or down, with the tilt frame 20 pivoting around the hinge arrangements 32.

Typically, each of the length adjustable arms 22 has a telescopic configuration (i.e. which are mechanically robust and reliable over time). In this regard, each length adjustable arm 22 comprises an outer base arm 36 and an inner telescoping arm 38. In use, (i.e. when the arm is freed for use), the inner telescoping arm 38 slides into and out of the outer base arm 36. The length of the length adjustable arm 22 is accordingly adjusted by the sliding action. The lower end 24 of base arm 36 is pivotally mounted via a hinge 37 to a respective and discrete cross brace 39 that forms part of the internal framework 14. The upper end 26 of the inner telescoping arm 38 is also pivotally mounted via a hinge 41 to a transverse cross member 43 of the tilt frame 20.

Each length adjustable arm 22 may have a more complex configuration. For example, each length adjustable arm 22 may take the form of a length adjustable (e.g. hydraulic or pneumatic) arm or ram. However, for remote and isolated applications of the solar skid 10, a more simple and reliable mechanical (e.g. telescopic) length adjustable arm is favoured.

As discussed previously, each of the length adjustable arms 22 comprises and its length is locked using a locking pin 40 (as best shown in FIG. 6). The locking pin 40 is configured to selectively lock the sliding of the inner telescoping arm 38 with respect to the outer base arm 36 through appropriately aligned holes 30 in each of the arms. With the pin removed, and once each length adjustable arm 22 is adjusted to its desired length, it is locked at that length by the locking pin 40 being inserted through aligned holes 30. The locking pin 40 is typically in the form of a separate but tethered pin, but may take the form of a captive (e.g. spring-loaded) pin, a detent-type catch, etc. The locking pin 40 is disengaged when the solar skid 10 is in the collapsed configuration.

Located within the base frame 12 of the solar skid 10 is at least one stop; in the embodiments depicted, and as best shown in FIGS. 8A and 8B, two stops in the form of two spaced-apart lands 42 are located on respective cross-members of the internal framework 14. When the solar panels 18 and tilt frame 20 are in the collapsed configuration, an underside of the tilt frame rests on top of the lands 42. The lands 42 typically have a deflection or spring-like characteristic for impact absorption (e.g. should the tilt frame 20 be dropped or firmly pushed onto the lands 42), so as to protect both the solar panels 18 and the internal framework 14 of solar skid 10.

The internal framework 14 also comprises spaced-apart hollow sections in the form of spaced-apart transverse rectangular hollow sections (RHS) 44. The RHS sections 44 extend between and open out of the front and rear sides of the perimeter framework 16 and are spaced such that they can receive a respective tine of a vehicle such as a forklift. This can allow for ready movement, lifting, placement and transport of the solar skid 10. The RHS sections 44 can also provide strength and rigidity to the base frame 12.

The perimeter framework 16 of the solar skid 10 also has a series of spaced apertures 46 through sidewalls and/or end walls thereof. The apertures 46 enable air (e.g. wind) to flow through the base frame 12 in use. In this regard, air may flow from one side/end of the perimeter framework 16 to the other. Such air flow can assist in wind load reduction on the solar skid 10 when located ‘out in the field’. The apertures 46 can also allow flood water to pass through the base frame 12. The apertures 46 in the end walls are covered by grommets 48, typically of rubber, for protection of electrical interconnecting cables as discussed below, such as when interconnecting adjacent solar skids 10 to each other.

The perimeter framework 16 of the base frame 12 of the solar skid 10 further comprises a number of alignment members in the form of locating members 50. The locating members 50 are located and provided to enable solar skids 10 to be guided, aligned and stacked on top of one another. Whilst just two locating members 50 could be located at respective, diagonally-opposite corners of the perimeter framework 16, typically each locating member 50 is located at a respective corner of the perimeter framework 16 of base frame 12, as shown in the Figures.

Each locating member 50 is specially configured to receive, guide and locate an underside corner of a respective overlying and like perimeter framework 16 of an overlying and like solar skid 10. In this regard, each locating member 50 comprises two outwardly flared flanges 52 that each extend along and project up and out from a respective side or end of the perimeter framework 16 at the respective corner. The flanges 52 act as both a guide and as retention surfaces, that is, to guide the solar skid 10 onto the underlying solar skid 10, and to also retain the underside corner of the overlying solar skid 10 as shown in the detail view of FIG. 14.

As best shown in FIG. 11, each of the opposite end walls of the perimeter framework 16 of base frame 12 additionally comprises spaced-apart, offset pin-receiving brackets in the form of connector brackets 54. The connector brackets 54 are mounted (e.g. spot-welded or riveted) to project externally of the perimeter framework 16. The offset arrangement of the connector brackets 54 is such that, when the solar skids 10 are stacked on top of one another, each left-hand bracket 54 vertically aligns with a corresponding left-hand bracket 54 of an overlying solar skid 10, and each right-hand bracket 54 vertically aligns with a corresponding right-hand bracket 54 of an overlying solar skid 10, as best shown in the detail view of FIG. 14. Thus, once the locating members 50 have facilitated alignment of the stacked solar skids 10, either a single (e.g. U shaped) locator pin, or a pair of pins, can be extended through the aligned connector brackets 54 of the respective solar skids to secure the solar skids together against lateral movement when stacked. For example, one or two long pins, or multiple shorter pins, can extend through the aligned brackets for the length of the stack. This can enhance the secure transportation of the stack.

The connector brackets 54 can also be used to secure together adjacent solar skids on the ground in use (e.g. such as when daisy-chained lengthwise together, as shown in FIG. 12). Additionally, the brackets 54 may even be employed for additional ground-securing (e.g. for receiving therethrough ground-driven locator pegs).

As best shown in FIGS. 3, 6 and 11, typically the end walls (and/or side walls) of the perimeter framework 16 of base frame 12 each have at least one ground-securing formation, in this case two spaced-apart and reverse-angled tubes 56, fastened (e.g. welded) externally thereat. Each tube 56 is mounted to framework 16 in a skewed-to-vertical orientation as shown. The tubes 56 enable securing of the base frame 12 and thereby the solar skid 10, to the ground in use. Each of the tubes 56 is arranged and configured so as to be able to receive a ground-securing peg or stake therethrough. Each tube 56 also comprises at least one locking bolt 57 extending therein. Once a peg/stake has been inserted through the tube and driven into the ground at an angle (i.e. in a skewed-to-vertical orientation), the bolt 57 on the side of the tube 56 can be tightened to secure the peg/stake in place against the base frame 12.

As best shown in FIG. 17, one or more of the end walls and/or side walls of the perimeter framework 16 of the base frame 12 each have at least one or more foundation-securing formations 122. In this case, the end walls and side walls each comprise two foundation-securing formations 122. As a result, each corner of the base frame 12 comprises two foundation-securing formations 122. The foundation-securing formations 112 are in the form of L-shaped brackets. The foundation-securing formations 122 are fastened (e.g. welded or screwed) to the one or more of the end walls and/or side walls of the base frame 12. Each foundation-securing formation 122, as shown in FIG. 17, has one portion attached to the base frame 12 and the other portion extending away from the base frame 12 so as to be inline with the base frame 12. Each foundation-securing formation 122 is configured to be flush to a surface (e.g.; concrete) when placed on the surface, where the surface is flat. The portion of the foundation-securing formation 122 that extends away from the base frame 12 has at least one hole to enable a foundation-engaging peg, such as a bolt, to be inserted into the hole. The base frame 12 may therefore be secured to the foundation that the base frame 12 is on.

Also shown in FIG. 17, typically the opposing side walls and/or end walls of the frame base 12 comprise one or more lifting formations 124. The lifting formations 124 may be in the form of a tie hole bracket. The lifting formations 124 may be secured to the upper region of the base frame 12. An upper curved portion of one or more of the lifting formations 124 extends above the solar panels 18 when the solar skid 10 is in the stowed or recessed position. The curved portion of the relevant lifting formation 124 preferably includes a hole. A carabiner or shackle (not shown), can be attached through the hole and a chain or sling (not shown) attached to the other end of the carabiner or shackle. Each lifting formation 124 may be attached to a separate carabiner or shackle and chain, such that a crane (not shown) may then connect to each chain or sling and lift the solar skid 10 into position in a stable manner. This may be particularly advantageous when the use of a forklift is not possible or is inconvenient.

As best shown in FIG. 10, each solar skid 10 has a DC isolator 58 located within a purpose-built recessed housing 59 of the perimeter framework 16 of base frame 12. The housing 59 is closed by a door 61. The DC isolator 58 is configured to enable the offtake of electricity generated by the solar panels 18. An electrical cable extends from the solar panels 18 to the DC isolator 58. The DC isolator 58 is located at a rear side of the perimeter framework 16 (i.e. the side opposite to the front side framework 16 at which the solar panels 18 pivot), so as to be isolated from the solar panels 18.

As set forth above, and as best shown in FIG. 5, an electrical cable opening within each end wall of the perimeter framework 16 can be provided and covered by a grommet 48, such as of rubber. The grommet 48 can provide electrical insulation and can also protect power cables from damage (e.g. from the base frame 12 and due to the rain/wind).

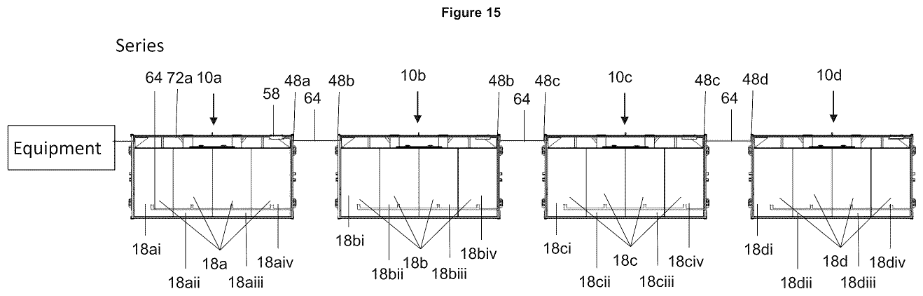

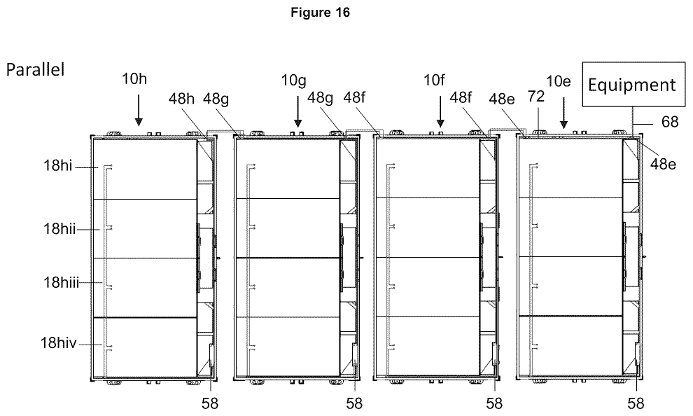

As previously described, each solar skid 10 is also configured to be electrically connected to one or more adjacent solar skids 10. As best shown in FIGS. 15 and 16, a solar skid 10a for example can be interconnected via a cable 64, which runs along the rear side of framework 16 in cable tray 72a on solar skid 10a, to another solar skid 10b in either a series (FIG. 15) or parallel (FIG. 16) configuration.

For example, solar skid 10a is placed into a series configuration as shown in FIG. 15. When in this configuration, each set of solar panels 18a is connected in series with the adjacent solar panels 18b of the adjacent solar skid 10b, with this repeating until the final solar skid 10d in the series configuration.

The first solar panel 18ai is connected to one side of the DC isolator 58. The remaining solar panels 18aii to 18aiv are, in this example, connected together in series as shown in FIG. 15. The first solar panel 18ai in solar skid 10a connects to a cable 64 that runs through grommet 48a on solar skid 10a and through grommet 48b of solar skid 10b. Cable 64 then connects to the first solar panel 18bi of the second solar skid 10b and the remaining solar panels 18bii, 18biii and 18biv in this example are connected in series. This continues on for each additional solar skid 10c and 10d in this example. The final solar skid 10d has a connection from the final solar panel 18div via cable 64, extending through all grommets 48a, 48b, 48c, 48d of each solar skid in the series configuration, to the DC isolator 58 in the first solar skid 10a.

As shown in FIG. 16, multiple solar skids 10e to 10h in this example, can be connected in a parallel configuration instead of in series, in accordance with Australian Standard AS/NZS5033:2014 (which sets the current installation and safety requirements for photovoltaic (PV) arrays). It is to be noted that, in the field, the array configuration shown in FIG. 16 would typically not be utilised. FIG. 16 has been drawn to demonstrate the parallel configurations of the interconnections, and to fit the configuration onto the constraints of the drawing. In practice, the solar skids 10 would be lined up end-to-end as shown in FIG. 12, but would have electrical interconnections between each solar skid 10 to place each solar skid 10 in parallel with each of the other solar skids 10 within the configuration.

It is also to be noted that a less desirable parallel configuration of the solar skids 10 would be to have each of the DC isolators 58 running a cable from each solar skid 10 to a combiner for combining the solar skids electrically into parallel, then feeding the output of the combiner to equipment to be powered. This is a less desirable setup, as the amount of cable utilised would be significantly increased, but may be appropriate for some applications. A more desirable setup for connecting the solar skids 10 into an electrically parallel configuration is described below.

In FIG. 16, the output of each DC isolator 58 connects electrically in parallel with each of the other solar skids 10e to 10h for the example shown, using an off the shelf adaptor (not shown) that is either in-line on the cable 68 or part of the DC isolator 58. The adaptor enables two cables to enter a connector and one cable to exit, i.e. a two-to-one adaptor. The cable 68 connects to the adaptor in the first solar skid 10e and then to the next adaptor in the adjacent solar skid 10f. This enables one set of cables 68 to be run to the power conversion device associated with the equipment, with multiple solar skids 10e to 10h (in this example), connected. The cable 68 runs along cable tray 72 and then through solar skids 10e to 10h respective grommets 48e to 48h, for the number of solar skids 10e to 10h that are in parallel, in this example. The solar panels 18hi, 18hii, 18hiii and 18hiv are all connected as previously in the series connection along with the solar panels of the other solar skids within this example (10f, 10g, 10h); it is simply the interconnection between the solar skids 10e to 10h (in this example) that is performed in the parallel configuration. The final solar skid 10d or 10h in the series or parallel configuration respectively, will then either be connected to a power storage device and/or conversion device for either storing and/or converting the electricity generated to a useable parameter for subsequent use. Such a device may be housed in the facility 100 shown in FIG. 12. FIG. 12 also shows an array of multiple (daisy-chained) solar skids 10 arranged in multiple parallel rows, to thereby generate maximum power output.

Whilst the solar skid has been described with reference to a number of specific embodiments, it should be understood that it may be embodied in other forms. For example, the skid may be square rather than rectangular, have a curve along its length to maximise its exposure to the sun, have a base tray at its underside, etc.

In the claims which follow and in the preceding description, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the unit.

What is claimed is:

1. An adjustable photovoltaic unit for providing electricity, the unit comprising:
a base;
one or more electrically connected photovoltaic panels;
a frame that is pivotably mounted to the base at an in-use lower region thereof, the one or more electrically connected photovoltaic panels being mounted to the frame;
at least one length-adjustable brace, one end of the brace being pivotally mounted with respect to the base, an opposing end of the brace being pivotally connected with respect to the frame at a location remote from where the frame is mounted to the base; and
a strut configured to apply a lifting force to the frame with respect to the base,
wherein an angle of inclination of the one or more panels with respect to the base is able to be varied by adjusting a length of the at least one brace.

2. The adjustable photovoltaic unit according to claim 1, wherein the unit comprises at least two length-adjustable braces, the at least two length-adjustable braces being spaced apart with respect to the base, with a first one of the at least two length-adjustable braces being mounted adjacent to one end of the base to extend up in use to connect adjacent to one end of the one or more panels, and with a second one of the at least two length-adjustable braces being located adjacent to an opposite end of the base to extend up in use to connect adjacent to an opposite end of the one or more panels.

3. The adjustable photovoltaic unit according to claim 2, wherein the unit comprises one or more struts, the struts being configured to assist in pivotal movement of the one or more panels mounted to the frame, with respect to the base, wherein one end of each strut is pivotally mounted with respect to the base, an opposing end of each strut being pivotally connected with respect to the frame at a location remote from where the frame is pivotably mounted to the base.

4. The adjustable photovoltaic unit according to claim 3, wherein the unit comprises at least two struts, one of the struts located adjacent to the first one of the braces, and another of the struts located adjacent to the second one of the braces.

5. The adjustable photovoltaic unit according to claim 4, further comprising an intermediate strut assembly positioned between two of the at least two struts, wherein the intermediate strut assembly is configured to assist in the pivotal movement of the frame with respect to the base, one end of the intermediate strut assembly being pivotally mounted with respect to the base, an opposing end of the intermediate strut assembly being pivotally connected with respect to the frame at a location remote from where the frame is mounted to the base, wherein the intermediate strut assembly comprises at least one gas strut.

6. The adjustable photovoltaic unit according to claim 5, wherein the intermediate strut assembly comprises a third strut at an end of the intermediate strut assembly closest to the base; and at least two tubular portions in a telescopic configuration that comprises an outer telescoping tubular portion and an inner telescoping tubular portion configured to slide into and out of the outer tubular portion, whereby a length of the intermediate strut assembly is adjustable, and wherein an upper end of the outer tubular portion is pivotably connected with respect to the frame at the location remote from where the frame is mounted to the base, wherein an in-use lower end of the inner telescoping tubular portion is mounted to the third strut, wherein the third strut is configured to provide initial lift to the frame.

7. The adjustable photovoltaic unit according to claim 1, wherein the frame comprises a sub-frame, wherein the one or more panels are mounted to the sub-frame, and wherein the sub-frame is pivotally mounted to the base at an in-use lower side of the sub-frame, with the opposing end of the at least one brace being pivotally connected to the sub-frame at a location remote from the lower side of the sub-frame.

8. The adjustable photovoltaic unit according to claim 7, further comprising one or more handles attached to the frame, such as by being attached to the sub-frame, the one or more handles enabling the frame to be pivoted up or down with respect to the base around the pivotal mounting.

9. The adjustable photovoltaic unit according to claim 1, wherein:
each brace has a telescopic configuration that comprises an outer base arm and an inner telescoping arm able to slide into and out of the outer base arm whereby the length of the brace is adjusted,
an in-use lower end of the outer base arm is pivotally mounted with respect to the base, and an in-use upper end of the inner telescoping arm is pivotally connected with respect to the frame, and
each brace further comprises a locking pin configured to selectively lock the sliding of the inner telescoping arm with respect to the outer base arm, whereby the brace is able to be adjusted to and locked in a number of different lengths.

10. The adjustable photovoltaic unit according to claim 1, wherein the frame is configured to pivot with respect to the base between a collapsed configuration, in which an underside of the one or more panels overlies the base, and at least one erected configuration in which the one or more panels extend up and away from the base at the angle of inclination.

11. The adjustable photovoltaic unit according to claim 10, the base further comprising at least one stop, such as two spaced-apart stops, wherein in the collapsed configuration an underside of the one or more panels or an underside of the frame rests on or with respect to the at least one stop.

12. The adjustable photovoltaic unit according to claim 1, wherein the base comprises a perimeter framework and internal framework that extends within and is connected to the perimeter framework.

13. An adjustable photovoltaic unit according to claim 12, wherein:
said one end of each brace is pivotally mounted to the internal framework of the base, and
the internal framework is recessed within the perimeter framework such that, in a collapsed configuration, the one or more panels overlie the internal framework and are located within the perimeter framework.

14. The adjustable photovoltaic unit according to claim 12, wherein the internal framework further comprises spaced-apart hollow sections that extend transversely between opposite respective openings defined in opposing sides of the perimeter framework, each hollow section being configured so as to slidingly receive therein a respective tine of a vehicle such as a forklift.

15. The adjustable photovoltaic unit according to claim 12, wherein the perimeter framework comprises a plurality of spaced apertures through sidewalls or end walls thereof, the apertures to enable air to flow through and from one side/end of the perimeter framework to another side/end of the perimeter framework to assist in wind load reduction.

16. The adjustable photovoltaic unit according to claim 1, wherein the base comprises a number of alignment members, each alignment member located at a respective corner of the base, each alignment member being configured to receive and locate an underside corner of a respective overlying like base of an overlying like unit to enable the units to be stacked.

17. The adjustable photovoltaic unit according to claim 16, wherein an alignment member is provided at each corner of the base, and wherein each alignment member comprises two flared flanges that each extend along and project up and out from a respective side/end of the base at the respective corner.

18. The adjustable photovoltaic unit according to claim 1, wherein:
each of opposing end walls of the base comprises spaced-apart pin-receiving brackets located externally thereat, each bracket able to align with a corresponding bracket of an overlying unit when the units are stacked, whereby a respective locator pin can be extended through aligned brackets to thereby secure the units against lateral movement when stacked, and
each of opposing end walls and/or side walls of the base comprises one or more ground-securing formations, such as a tube, each ground-securing formation located externally on a respective base wall and arranged and configured to receive a ground-engaging peg therethrough such that, when the base is located on the ground in use, a ground-engaging peg can be driven into the ground, such as in a skewed-to-vertical orientation, the peg extending through and being retained at a respective ground-securing formation to thereby secure the base at the ground.

19. The adjustable photovoltaic unit according to claim 1, wherein one or more end walls and/or side walls of the base comprise one or more foundation-securing formations, each foundation-securing formation located externally on a respective end wall or side wall and arranged to receive a foundation-engaging peg, such that when the base is located on a foundation the foundation-engaging peg can be inserted into the foundation to secure the base to the foundation.

20. The adjustable photovoltaic unit according to claim 1, wherein one or more side wall and/or end wall of the base comprises one or more lifting formations, each lifting formation located externally on the respective side wall or end wall and arranged and configured to receive a hook through a hole of the respective lifting formation.

21. The adjustable photovoltaic unit according to claim 1, wherein the unit comprises two or more panels having a same dimension, the two or more panels arranged adjacent to each other in a row that extends between opposing ends of the base and/or the two or more panels arranged adjacent to each other in a column that extends between opposing sides of the base.

22. The adjustable photovoltaic unit according to claim 21, wherein the two or more panels are surrounded by and contained within an external panel perimeter frame, and mounted to the frame, such that the two or more panels pivot as a unit about the lower region and with respect to the base, the panel perimeter frame connected to a sub-frame when present.

23. The adjustable photovoltaic unit according to claim 1, further comprising a DC isolator component located within the base, the DC isolator component configured to enable offtake of electricity generated by the one or more panels, wherein at least one cable extends from the one or more panels to the DC isolator component.

24. The adjustable photovoltaic unit according to claim 23, wherein:
in use, an electrical connection is able to be established between adjacent units via the DC isolator component,
the DC isolator component is located at a rear side of the base, opposite a front side at which the frame pivots, the electrical connection able to be established via a further cable that extends through an opening within an end wall of the base that is adjacent to the DC isolator component located at the rear side of the base, and
each opening is covered by a grommet, such as of rubber, the further cable extending through the grommet.

25. The adjustable photovoltaic unit according to claim 1, wherein the strut is a gas strut.

26. An adjustable photovoltaic unit for providing electricity, the unit comprising:
a base; and
one or more electrically connected photovoltaic panels pivotally mounted with respect to the base for movement between a collapsed configuration and one or more erected configurations;
wherein the base comprises at least two alignment members, each alignment member located at a respective corner of the base such that, when the one or more panels are in the collapsed configuration, each alignment member is configured to receive and locate an underside corner of a respective overlying like base of an overlying like unit to enable a plurality of units to be stacked.

27. The adjustable photovoltaic unit according to claim 26, further comprising:
a frame that is pivotably mounted to the base at an in-use lower region thereof, the one or more electrically connected photovoltaic panels being mounted to the frame;
at least one length-adjustable brace, one end of the brace being pivotally mounted with respect to the base, an opposing end of the brace being pivotally connected with respect to the frame at a location remote from where the frame is mounted to the base; and
a strut configured to apply a lifting force to the frame with respect to the base,
wherein an angle of inclination of the one or more panels with respect to the base is able to be varied by adjusting a length of the at least one brace.

28. The adjustable photovoltaic unit according to claim 26, wherein an alignment member is provided at each corner of the base, and wherein each alignment member comprises two flared flanges that each extend along and project up and out from a respective side/end of the base at the respective corner.

29. An adjustable photovoltaic unit for providing electricity, the unit comprising:
a base;
one or more electrically connected photovoltaic panels pivotally mounted with respect to the base for movement between a collapsed configuration and one or more erected configurations,
wherein an external wall of the base comprises at least one ground-securing formation, each ground-securing formation being arranged and configured to receive a ground-engaging peg therethrough such that, when the base is located on the ground in use, a ground-engaging peg can be driven into the ground to secure the base at the ground;
a frame that is pivotably mounted to the base at an in-use lower region thereof, the one or more electrically connected photovoltaic panels being mounted to the frame;
at least one length-adjustable brace, one end of the brace being pivotally mounted with respect to the base, an opposing end of the brace being pivotally connected with respect to the frame at a location remote from where the frame is mounted to the base; and
a strut configured to apply a lifting force to the frame with respect to the base,
wherein an angle of inclination of the one or more panels with respect to the base is able to be varied by adjusting a length of the at least one brace.

30. The adjustable photovoltaic unit according to claim 29, wherein:
the ground-securing formations are in the form of a tube, each ground-securing formation located externally on a respective base wall and arranged and configured to receive the ground-engaging peg therethrough such that, when the base is located on the ground in use, a ground-engaging peg can be driven into the ground, such as in a skewed-to-vertical orientation, the peg extending through and being retained at a respective ground-securing formation to thereby secure the base at the ground.
